(19) United States
(12) Patent Application Publication
(10) Pub. No.: US 2022/0100561 A1
(43) Pub. Date: Mar. 31, 2022

(54) TIMER-BASED TASK PROCESSING METHOD AND APPARATUS AND ELECTRONIC DEVICE

(71) Applicant: Autel Intelligent Technology Corp., Ltd., Shenzhen (CN)

(72) Inventor: Minghua ZHAO, Shenzhen (CN)

(73) Assignee: Autel Intelligent Technology Corp., Ltd., Shenzhen (CN)

(21) Appl. No.: 17/533,100

(22) Filed: Nov. 22, 2021

Related U.S. Application Data
(63) Continuation of application No. PCT/CN2020/096809, filed on Jun. 18, 2020.

(30) Foreign Application Priority Data
Jun. 19, 2019 (CN) 201910530881.0

(51) Int. Cl. G06F 9/48; G06F 16/901

(52) U.S. Cl. CPC G06F 9/4887; G06F 16/9024

(57) ABSTRACT

The disclosure relates to the field of computer technologies, and in particular, to a timer-based task processing method and apparatus and an electronic device. The method includes: acquiring a countdown time of a timer object according to a first timer; and controlling a second timer to perform countdown according to the countdown time and processing a task corresponding to the timer object when the countdown is completed. According to this implementation, the timer object is controlled by using two timers, which improves operating efficiency of the timer object, reduces an error accumulation effect and improves timing accuracy.

### CROSS-REFERENCE TO RELATED APPLICATIONS

The present application is a continuation application of International Application No. PCT/CN2020/096809, filed on Jun. 18, 2020, which claims priority of Chinese Patent Application No. 201910530881.0, filed on Jun. 19, 2019, which is incorporated herein by reference in its entirety.

### TECHNICAL FIELD

The disclosure relates to the field of computer technologies, and in particular, to a timer-based task processing method and apparatus and an electronic device.

### DESCRIPTION OF RELATED ART

During development of embedded software based on a real-time operating system, timers are frequently used in a business logic to complete specific functions. A function of the timers is to control a time interval for the software to wait for an event to occur. The timers generally include a hardware timer and a software timer. The hardware timer generates a timing event by using an interrupt. The software timer is implemented by using a time slice. During specific implementation, queues, including single-queue and double-queue, are usually used to manage and control the timers.

During implementation of the disclosure, the inventor finds at least the following problems in the related art: triggering of task processing by using a timer has low efficiency and has an error accumulation effect, resulting in inaccurate timing.

### SUMMARY

A technical problem to be resolved in the disclosure is to provide a timer-based task processing method and apparatus and an electronic device, to resolve technical problems such as low efficiency and inaccurate timing in the related technology.

An aspect of embodiments of the disclosure provides a timer-based task processing method, including:
acquiring a countdown time of a timer object according to a first timer; and
controlling a second timer to perform countdown according to the countdown time and processing a task corresponding to the timer object when the countdown is completed.

Optionally, the acquiring a countdown time of a timer object according to a first timer includes:
acquiring an absolute timestamp according to the first timer;
acquiring a preset timing moment of the timer object; and
calculating a difference between the preset timing moment and the absolute timestamp, the difference obtained being taken as the countdown time of the timer object.

Optionally, when the timer object includes a plurality of timer objects, the method further includes:
ordering the plurality of timer objects in a linked list;
acquiring a countdown time of a first timer object in the linked list according to the first timer; and
controlling the second timer to perform countdown according to the countdown time of the first timer object, processing a task corresponding to the first timer object when the countdown is completed, repeating the foregoing steps of acquiring the countdown time and performing countdown according to the countdown time until tasks corresponding to all of the timer objects in the linked list are processed and proceeding to a next cycle.

Optionally, the ordering the plurality of timer objects in a linked list specifically includes:
ordering the plurality of timer objects in the linked list in a chronological order according to preset timing moments respectively corresponding to the plurality of timer objects.

Optionally, the method further includes: inserting a new timer object into the linked list.

Optionally, the method further includes: deleting the timer objects from the linked list.

Another aspect of embodiments of the disclosure provides a timer-based task processing apparatus, including:
a first acquisition module, configured to acquire a countdown time of a timer object according to a first timer; and
a first processing module, configured to control a second timer to perform countdown according to the countdown time and process a task corresponding to the timer object when the countdown is completed.

Optionally, the first acquisition module is specifically configured to:
acquire an absolute timestamp according to the first timer;
acquire a preset timing moment of the timer object; and
calculate a difference between the preset timing moment and the absolute timestamp, the difference obtained being taken as the countdown time of the timer object.

Optionally, when the timer object includes a plurality of timer objects, the apparatus further includes:
an ordering module, configured to order the plurality of timer objects in a linked list;
a second acquisition module, configured to acquire a countdown time of the first timer object in the linked list according to the first timer; and
a second processing module, configured to control the second timer to perform countdown according to the countdown time of the first timer object, process a task corresponding to the first timer object when the countdown is completed, repeat the foregoing steps of acquiring the countdown time and performing countdown according to the countdown time until tasks corresponding to all of the timer objects in the linked list are processed and proceed to a next cycle.

Optionally, the ordering module is specifically configured to:
order the plurality of timer objects in the linked list in a chronological order according to preset timing moments respectively corresponding to the plurality of timer objects.

Optionally, the apparatus further includes:
an insertion module, configured to insert a new timer object into the linked list.

Optionally, the apparatus further includes:
a deletion module, configured to delete the timer objects from the linked list.

Still another aspect of the embodiments of the disclosure provides an electronic device. The electronic device includes a first timer, configured to acquire a countdown time of a timer object; a second timer, configured to perform countdown according to the countdown time; at least one processor; and a memory communicatively connected to the at least one processor. The first timer and the second timer are both coupled to the processor. The memory stores instructions which are executable by the at least one processor to perform the method described above.

In the embodiments of the disclosure, two timers are configured. The countdown time of the timer object is acquired by using the first timer. Countdown is performed by using the second timer according to the countdown time. The task corresponding to the timer object is processed when the countdown is completed. According to this implementation, the timer object is controlled by using two timers. This implementation improves operating efficiency of the timer object, reduces an error accumulation effect and improves timing accuracy.

### BRIEF DESCRIPTION OF THE DRAWINGS

One or more embodiments are exemplarily described with reference to the corresponding figures in the accompanying drawings. The descriptions are not to be construed as limiting the embodiments. Elements in the accompanying drawings that have same reference numerals are represented as similar elements. Unless otherwise particularly stated, the figures in the accompanying drawings are not drawn to scale.

FIG. 1 is a flowchart of a timer-based task processing method according to an embodiment of the disclosure.

FIG. 2 is a flowchart of a method for acquiring a countdown time of a timer object according to a first timer according to an embodiment of the disclosure.

FIG. 3 is a flowchart of a timer-based task processing method according to another embodiment of the disclosure.

FIG. 4 is a schematic flowchart of task processing for a plurality of timer objects according to an embodiment of the disclosure.

FIG. 5 is a schematic structural diagram of a timer-based task processing apparatus according to an embodiment of the disclosure.

FIG. 6 is a schematic diagram of a hardware structure of an electronic device performing a timer-based task processing method according to an embodiment of the disclosure.

### DETAILED DESCRIPTION

To make the objectives, technical solutions, and advantages of the present disclosure clearer and more comprehensible, the following further describes the present disclosure in detail with reference to the accompanying drawings and embodiments. It should be understood that the embodiments herein are provided for describing the disclosure but not intended to limit the present invention.

It should be noted that, if no conflict occurs, features in the embodiments of the disclosure may be combined with each other and fall within the protection scope of the disclosure. In addition, functional module division is performed in the schematic diagram of the apparatus, and a logical sequence is shown in the flowchart. However, in some cases, the shown or described steps may be performed by using module division different from the module division in the diagram of apparatus, or in a sequence different from the sequence in the flowchart.

Embodiments of the disclosure provide a timer-based task processing method and apparatus. Inventive principles of the timer-based task processing method and apparatus are as follows:

Two hardware timers are adopted to process a task corresponding to a timer object in the embodiments of the disclosure. A first timer is configured to generate an absolute timestamp. The absolute timestamp is a time reference for an entire timing system and may be understood as the system time. A second timer is configured to perform countdown according to a countdown time of the timer object. The countdown time of the timer object is calculated according to the absolute timestamp and a preset timing moment.

During actual application, the absolute timestamp is generated upon enable of the first timer. The second timer starts countdown according to the countdown time of the timer object. When the preset timing moment is reached, the second timer generates a timing interrupt. In this case, a task corresponding to a callback function in the timer object is processed. At the same time, the first timer continues to obtain a current absolute timestamp and a countdown time of the second timer object is calculated according to the current absolute timestamp and a preset timing moment corresponding to a second timer object. Then the second timer performs countdown for the second timer object according to the countdown time, and processes a task corresponding to a callback function in the second timer object when the countdown is completed, and so on, until all timer objects are processed.

The foregoing timer objects may be stored in a linked list. Each of the timer objects may be ordered according to a preset timing moment to form a circular linked list.

By using the foregoing two hardware timers, a timing event is set, and a plurality of timing events may be created. In addition, the system only needs to access a timer object reaching a timing duration, without a need to access all timer objects at every moment. This significantly reduces CPU usage and improves operating efficiency of the timer objects. In addition, the embodiments of the disclosure generate no accumulative errors and improve timing accuracy.

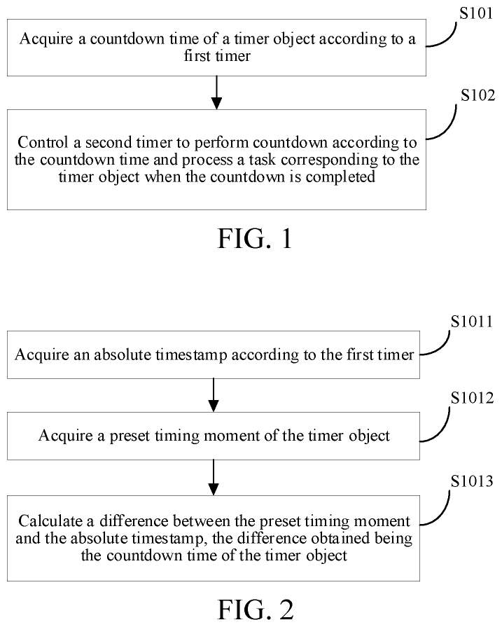

FIG. 1 is a flowchart of a timer-based task processing method according to an embodiment of the disclosure. As shown in FIG. 1, the method includes the following steps:

Step S101: Acquire a countdown time of a timer object according to a first timer.

The first timer may be specifically a hardware timer.

The timer object includes a relative timing duration, an absolute timing moment, a timing callback function, a previous timer object and a next timer object. The relative timing duration is a duration relative to the absolute timestamp and the absolute timing moment and is equal to the absolute timing moment minus the absolute timestamp. The absolute timing moment is a preset time point. The absolute timing moment may be customized by the system or may be set by a user according to personal preferences. When the absolute timing moment is reached, an event corresponding to the timer object is triggered. The timing callback function may be empty or may include at least one task event. The task event may be specifically set according to a corresponding application scenario. For example, the task event is a bell, a meeting notification or the like. The previous timer object and the next timer object are two timer objects adjacent to a current timer object. For example, when a plurality of timer objects forms a circular linked list, a previous timer object of the first timer object is a timer object at an end of the circular linked list and a next timer object of the first timer object is the second timer object. For another example, when a plurality of timer objects form a unidirectional linked list, a previous timer object of the first timer object is empty, and a next timer object of the first timer object is the second timer object.

The countdown time is a time used to trigger execution of a task corresponding to the timing callback function. The countdown time is used by the second timer. The second timer performs countdown according to the countdown time and executes the task corresponding to the timing callback function in the timer object when the countdown is completed.

Referring to FIG. 2, the acquiring a countdown time of a timer object according to a first timer specifically includes the following steps:

Step S1011: Acquire an absolute timestamp according to the first timer.

The absolute timestamp is a system time of an entire timing system. The first timer may read the absolute timestamp by using a preset interface. The absolute timestamp may be acquired upon enable of the first timer.

Step S1012: Acquire a preset timing moment of the timer object.

The preset timing moment is the foregoing absolute timing moment, which is a preset time point. The preset timing moment may be customized by the system or may be set by a user according to personal preferences. When the preset timing moment is reached, an event corresponding to the timer object is executed.

Step S1013: Calculate a difference between the preset timing moment and the absolute timestamp, the difference obtained being taken as the countdown time of the timer object.

The countdown time is equal to the preset timing moment minus the absolute timestamp.

The absolute timestamp may be acquired a plurality of times by using the first timer within a preset time, to obtain a plurality of countdown times. Then an average value of the plurality of countdown times is acquired. The average value is taken as the countdown time. In this way, the countdown time is more accurate.

Step S102: Control a second timer to perform countdown according to the countdown time and process a task corresponding to the timer object when the countdown is completed.

The second timer may also be a hardware timer. When the first timer is enabled, the second timer is also enabled to perform countdown according to the countdown time. Whether the countdown is completed may be determined by detecting an interrupt of the second timer. When the second timer is interrupted, the countdown is completed. In this case, a task corresponding to a callback function in the timer object is processed.

The foregoing process is described below in detail by using an example. For example, a timer is enabled, and a current absolute timestamp 10000 (the timestamp is a value accumulated once at a fixed time) is acquired. It is assumed that a unit is microsecond herein. A preset timing moment of a timer object Ta1 is acquired as 15000. In this case, a countdown time of the timer object Ta1 is 5000 microseconds. Another timer also starts to perform countdown when the timer is enabled. When the countdown of 5000 microseconds is completed, a task corresponding to the timer object Ta1 is processed. The task is specifically a task corresponding to a timing callback function in the timer object Ta1.

The embodiment of the disclosure provides a timer-based task processing method. In the method, two timers are configured to trigger execution of the task corresponding to the timer object. During triggering of a timing event, a time reference, that is, an absolute timestamp is generated by using the timer. A set timing (that is, the countdown time) is calculated based on the absolute timing moment and the absolute timestamp each time. The embodiment of the disclosure generates no accumulative error effect. In this way, timing accuracy and operating efficiency of the timer object are improved.

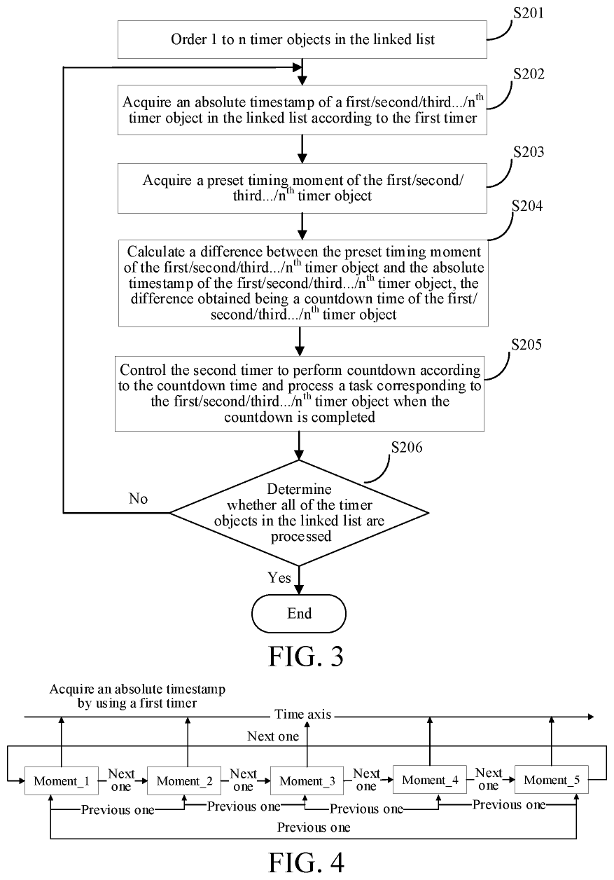

Referring to FIG. 3, when the timer object includes a plurality of timer objects, the method further includes the following steps:

Step S201: Order the plurality of timer objects in a linked list.

The linked list may be specifically a circular linked list. Certainly, other data structures such as a queue, a unidirectional linked list, a bidirectional linked list and the like may also be used to store the timer objects.

The plurality of timer objects in the linked list may be specifically ordered according to a chronological order of preset timing moments corresponding to the timer objects. For example, the circular linked list includes timer objects Ta1, Ta2 and Ta3, and preset timing moments of the timer objects Ta1, Ta2 and Ta3 are respectively 15000, 20000 and 40000.

Step S202: Acquire an absolute timestamp of a first timer object in the linked list according to the first timer.

Step S203: Acquire a preset timing moment of the first timer object.

Step S204: Calculate a difference between the preset timing moment of the first timer object and the absolute timestamp of the first timer object, the difference obtained being taken as the countdown time of the first timer object.

The steps of acquiring the absolute timestamp, the preset timing moment and the countdown time are the same as those in the foregoing embodiment. Therefore, for details of steps S202 to S204, reference may be made to the foregoing embodiment, and the details will not be described herein again.

Step S205: Control a second timer to perform countdown according to the countdown time and execute a task corresponding to the first timer object when the countdown is completed.

Step S206: Determine whether all timer objects in the linked list have been processed, and if not, repeat steps S202 to S205 until tasks corresponding to all of the timer objects are executed.

During step S202 to step S205, an absolute timestamp and a preset timing moment corresponding to a timer object currently being processed are acquired according to the time object. During processing of different timer objects, absolute timestamps vary and preset timing moments of the different timer objects also vary. Certainly, if two or more timer objects have the same preset timing moment, based on the foregoing principle, a plurality of timing systems each including two timers may be configured to process the plurality of timer objects having the same preset timing moment.

A specific process of processing the plurality of timer objects according to the first timer and the second timer is described below by using examples. For example, referring to FIG. 4, FIG. 4 shows five timer objects: Moment 1, Moment 2, Moment 3, Moment 4 and Moment 5. A previous timer object of Moment 1 is Moment 5 and a next timer object of Moment 5 is Moment 1. During task processing, a countdown time of Moment 1 is acquired by using the first timer, that is, an absolute timestamp of Moment 1 is acquired according to the first timer, a preset timing moment of Moment 1 is acquired, and the absolute timestamp is subtracted from the preset timing moment to obtain the countdown time of Moment 1. Then the second timer performs countdown according to the countdown time and processes a task corresponding to Moment 1 when the countdown is completed. At the same time, an absolute timestamp of Moment 2 is acquired by using the first timer, a preset timing moment of Moment 2 is acquired, and a countdown time of Moment 2 is calculated. The second timer performs countdown according to the countdown time of Moment 2 and processes a task corresponding to Moment 2 when the countdown is completed, and so on, until a task corresponding to Moment 5 is processed, and starts a next cycle from Moment 1.

The plurality of timer objects are processed based on the circular linked list and the two timers. During triggering of a timing event of each of the timer objects, a redundant traversal operation of the timers is not required, and no accumulative error effect is generated. Therefore, the timing accuracy and the operating efficiency of the timer object are improved.

Based on FIG. 3, the method further includes: inserting a new timer object into the linked list. The inserted new timer object may correspond to a new task. Addresses of the objects in the linked list and absolute timing moments (that is, preset timing moments) corresponding to the timer objects may be stored in a two-dimensional array according to a chronological order of the absolute timing moments. The two-dimensional array is searched by dichotomy for a corresponding timer object. Compared with an existing timer object searching method, this method can significantly improve timer object searching efficiency. Certainly, in actual applications, the timer object may also be inserted by using other methods.

Based on FIG. 3, the method further includes: deleting the timer object from the linked list. During deletion of the timer object, addresses of the objects in the linked list and absolute timing moments (that is, preset timing moments) corresponding to the timer objects may be stored in a two-dimensional array according to a chronological order of the absolute timing moments. The two-dimensional array is searched by dichotomy for a to-be-deleted timer object. A mapping relationship between timer objects before and after the timer object in the linked list is updated.

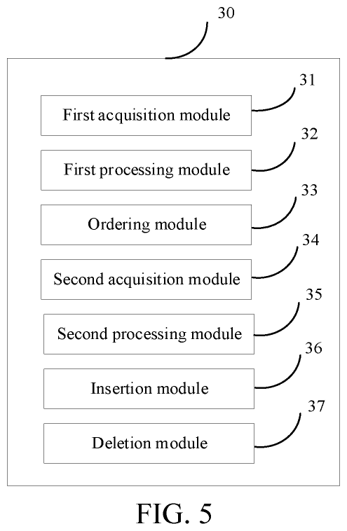

Referring to FIG. 5, FIG. 5 is a schematic structural diagram of a timer-based task processing apparatus according to an embodiment of the disclosure. The apparatus 30 includes a first acquisition module 31 and a first processing module 32.

The first acquisition module 31 is configured to acquire a countdown time of a timer object according to a first timer. The first processing module 32 is configured to control a second timer to perform countdown according to the countdown time and process a task corresponding to the timer object when the countdown is completed.

The first acquisition module 31 is specifically configured to acquire an absolute timestamp according to the first timer, acquire a preset timing moment of the timer object, and calculate a difference between the preset timing moment and the absolute timestamp. The difference obtained is taken as the countdown time of the timer object.

Referring to FIG. 5, the apparatus 30 further includes an ordering module 33, a second acquisition module 34 and a second processing module 35. The ordering module 33 is configured to order the plurality of timer objects in a linked list. The second acquisition module 34 is configured to acquire a countdown time of the first timer object in the linked list according to the first timer. The second processing module 35 is configured to control the second timer to perform countdown according to the countdown time of the first timer object, process a task corresponding to the first timer object when the countdown is completed, repeat the steps of acquiring the countdown time and performing countdown according to the countdown time until tasks corresponding to all of the timer objects in the linked list are processed and proceed to a next cycle.

The ordering module 33 is specifically configured to order the plurality of timer objects in the linked list in a chronological order according to preset timing moments respectively corresponding to the plurality of timer objects.

Referring to FIG. 5, the apparatus 30 further includes an insertion module 36 and a deletion module 37. The insertion module 36 is configured to insert a new timer object into the linked list. The deletion module 37 is configured to delete the timer object from the linked list.

It should be noted that content such as information exchange and an execution process between the modules and the units in the apparatus is based on a same idea as the method embodiments of the disclosure. Therefore, for details, reference may be made to descriptions in the method embodiments of the disclosure, and the details will not be described herein again.

The embodiment of the disclosure provides a timer-based task processing apparatus. In the apparatus, two timers are set to trigger execution of the task corresponding to the timer object. During triggering of a timing event, a time reference, that is, an absolute timestamp is generated by using the timer. A set timing (that is, the countdown time) is calculated based on the absolute timing moment and the absolute timestamp each time. In addition, when there are a plurality of timer objects, in the embodiment of the disclosure, the plurality of timer objects are processed based on the circular linked list and the two timers. During triggering of a timing event of each of the timer objects, a redundant traversal operation of the timers is not required, and no accumulative error effect is generated. Therefore, the timing accuracy and the operating efficiency of the timer object are improved.

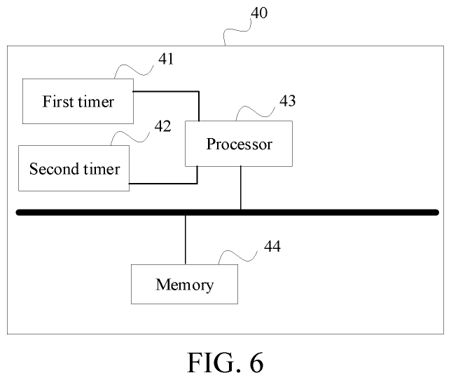

Referring to FIG. 6, FIG. 6 is a schematic diagram of a hardware structure of an electronic device performing a timer-based task processing method according to an embodiment of the disclosure. As shown in FIG. 6, the electronic device 40 includes a first timer 41, a second timer 42, one or more processors 43 and a memory 44. In FIG. 5, one processor 43 is used as an example.

The first timer 41 is configured to acquire a countdown time of a timer object, the countdown time being calculated according to an absolute timestamp and an absolute timing moment of the timer object. The second timer 42 is configured to perform countdown for the timer object according to the countdown time.

The first timer 41 and the second timer 42 are both coupled to the processor.

The processor 43 and the memory 44 may be connected by using a bus or in another manner. A connection by using the bus is used as an example in FIG. 6.

As a non-volatile computer readable storage medium, the memory 44 may be configured to store a non-volatile software program, a non-volatile computer executable program and a module, such as program instructions/modules (for example, the first acquisition module 31 and the first processing module 32 shown in FIG. 5) corresponding to the timer-based task processing method in the embodiments of the disclosure. The processor 43 performs various functional applications and data processing of a server by running the non-volatile software program, instruction and module stored in the memory 44. That is to say, the processor implements the timer-based task processing method described in the foregoing method embodiments.

The memory 44 may include a program storage area and a data storage area. The program storage area may store an operating system, an application program required by at least one function and the like. The data storage area may store data created according to use of the timer-based task processing apparatus or the like. In addition, the memory 44 may include a high speed random access memory, and may also include a non-volatile memory, such as at least one magnetic disk storage device, a flash memory, or another volatile solid-state storage device. In some embodiments, the memory 44 optionally includes memories remotely disposed relative to the processor 43. These remote memories may be connected to the timer-based task processing apparatus by using a network. Examples of the network include, but not limited to, the Internet, an intranet, a local area network, a mobile communication network, and a combination thereof.

The one or more modules are stored in the memory 44 and perform, when executed by the one or more processors 43, the timer-based task processing method according to any of the foregoing method embodiments. For example, the one or more modules perform the method steps S101 to S102 in FIG. 1, the method steps S1011 to S1013 in FIG. 2 and the method steps S201 to S206 in FIG. 3 described above to implement the functions of the modules 31-37 in FIG. 5.

For the foregoing product, the method provided in the embodiments of the present application may be performed, and the corresponding functional modules for performing the method and beneficial effects thereof are provided. For technical details not described in detail in this embodiment, refer to the method provided in the embodiments of the disclosure.

The electronic device in the embodiments of the disclosure exists in various forms, including but not limited to a mobile robot and other electronic device having a data interaction function.

An embodiment of the disclosure provides a non-volatile computer-readable storage medium storing computer-executable instructions. The computer-executable instructions are executed by an electronic device to perform the timer-based task processing method according to any of the foregoing method embodiments. For example, the method steps S101 to S102 in FIG. 1, the method steps S1011 to S1013 in FIG. 2 and the method steps S201 to S206 in FIG. 3 described above to implement the functions of the modules 31-37 in FIG. 5 are performed.

An embodiment of the disclosure provides a computer program product. The computer program product includes a computer program stored in a non-volatile computer-readable storage medium. The computer program includes program instructions which, when executed by a computer, cause the computer to perform the timer-based task processing method according to any of the foregoing method embodiments. For example, the method steps S101 to S102 in FIG. 1, the method steps S1011 to S1013 in FIG. 2 and the method steps S201 to S206 in FIG. 3 described above to implement the functions of the modules 31-37 in FIG. 5 are performed.

The foregoing described apparatus embodiments are merely examples. The units described as separate parts may or may not be physically separate. The parts displayed as units may or may not be physical units, may be located in one position, or may be distributed on a plurality of network units. Some or all of the modules may be selected according to actual needs to implement the objectives of the solutions of the embodiments.

Based on the descriptions of the foregoing implementations, those of ordinary skill in the art may clearly understand that the implementations may be implemented by software in addition to a universal hardware platform, or by hardware. Those of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The foregoing storage medium may include a magnetic disc, an optical disc, a read-only memory (ROM), a random access memory (RAM), or the like.

Finally, it should be noted that the foregoing embodiments are merely used for describing the technical solutions of the disclosure, but are not intended to limit the disclosure. Under the concept of the disclosure, the technical features in the foregoing embodiments or different embodiments may be combined, the steps may be implemented in any sequence, and there may be many other changes in different aspects of the disclosure as described above. For brevity, those are not provided in detail. The disclosure is described in detail with reference to the foregoing embodiments. However, those of ordinary skill in the art should understand that they may still make modifications to the technical solutions described in the foregoing embodiments or make equivalent replacements to some technical features thereof, without departing from the scope of the technical solutions of the embodiments of the disclosure.

What is claimed is:

1. A timer-based task processing method, comprising:
acquiring a countdown time of a timer object according to a first timer; and
controlling a second timer to perform countdown according to the countdown time, and processing a task corresponding to the timer object when the countdown is completed.

2. The method according to claim 1, wherein acquiring a countdown time of a timer object according to a first timer comprises:
acquiring an absolute timestamp according to the first timer;
acquiring a preset timing moment of the timer object; and
calculating a difference between the preset timing moment and the absolute timestamp, wherein the difference is taken as the countdown time of the timer object.

3. The method according to claim 1, wherein when there is a plurality of timer objects, the method further comprises:
ordering the plurality of timer objects in a linked list;
acquiring a countdown time of a first timer object in the linked list according to the first timer; and
controlling the second timer to perform countdown according to the countdown time of the first timer object, processing a task corresponding to the first timer object when the countdown is completed, repeating the foregoing steps of acquiring the countdown time and performing countdown according to the countdown time until tasks corresponding to all of the timer objects in the linked list are processed.

4. The method according to claim 3, wherein ordering the plurality of timer objects in a linked list specifically comprises:
ordering the plurality of timer objects in the linked list in a chronological order according to preset timing moments respectively corresponding to the plurality of timer objects.

5. The method according to claim 3, further comprising:
inserting a new timer object into the linked list.

6. The method according to claim 3, further comprising:
deleting the timer objects from the linked list.

7. A timer-based task processing apparatus, comprising:
a first acquisition module, configured to acquire a countdown time of a timer object according to a first timer; and
a first processing module, configured to control a second timer to perform countdown according to the countdown time and process a task corresponding to the timer object when the countdown is completed.

8. The apparatus according to claim 7, wherein the first acquisition module is specifically configured to:
acquire an absolute timestamp according to the first timer;
acquire a preset timing moment of the timer object; and
calculate a difference between the preset timing moment and the absolute timestamp, wherein the difference obtained is taken as the countdown time of the timer object.

9. The apparatus according to claim 7, wherein when there is a plurality of timer objects, the apparatus further comprises:
an ordering module, configured to order the plurality of timer objects in a linked list;
a second acquisition module, configured to acquire a countdown time of a first timer object in the linked list according to the first timer; and
a second processing module, configured to control the second timer to perform countdown according to the countdown time of the first timer object, process a task corresponding to the first timer object when the countdown is completed, repeat the foregoing steps of acquiring the countdown time and performing countdown according to the countdown time until tasks corresponding to all of the timer objects in the linked list are processed.

10. The apparatus according to claim 9, wherein the ordering module is further configured to:
order the plurality of timer objects in the linked list in a chronological order according to preset timing moments respectively corresponding to the plurality of timer objects.

11. The apparatus according to claim 9, further comprising:
an insertion module, configured to insert a new timer object into the linked list.

12. The apparatus according to claim 9, further comprising:
a deletion module, configured to delete the timer object from the linked list.

13. An electronic device, comprising:
a first timer, configured to acquire a countdown time of a timer object;
a second timer, configured to perform countdown according to the countdown time;
at least one processor; and
a memory communicatively connected to the at least one processor;
wherein the first timer and the second timer are both coupled to the processor; and
the memory storing instructions executable by the at least one processor to perform the following operations:
acquiring a countdown time of the timer object according to the first timer; and
controlling the second timer to perform countdown according to the countdown time, and processing a task corresponding to the timer object when the countdown is completed.

14. The electronic device according to claim 13, wherein the acquiring operation comprises:
acquiring an absolute timestamp according to the first timer;
acquiring a preset timing moment of the timer object; and
calculating a difference between the preset timing moment and the absolute timestamp, wherein the difference is taken as the countdown time of the timer object.

15. The electronic device according to claim 13, wherein when there is a plurality of timer objects, the at least one processor further performs operations:
ordering the plurality of timer objects in a linked list;
acquiring a countdown time of a first timer object in the linked list according to the first timer; and
controlling the second timer to perform countdown according to the countdown time of the first timer object, processing a task corresponding to the first timer object when the countdown is completed, repeating the foregoing steps of acquiring the countdown time and performing countdown according to the countdown time until tasks corresponding to all of the timer objects in the linked list are processed.

16. The electronic device according to claim 15, wherein the plurality of timer objects is ordered in a linked list by means of:
ordering the plurality of timer objects in the linked list in a chronological order according to preset timing moments respectively corresponding to the plurality of timer objects.

17. The electronic device according to claim 15, wherein the at least one processor further performs an operation: inserting a new timer object into the linked list.

18. The electronic device according to claim 15, wherein the at least one processor further performs an operation: deleting the timer object from the linked list.
